(19) United States
(12) Patent Application Publication
(10) Pub. No.: US 2023/0027380 A1
(43) Pub. Date: Jan. 26, 2023

(54) CREATING AND DEPLOYING LOCATION-BASED EVENT-TRIGGERED CRYPTOGRAPHIC TOKENS FOR GATED ACCESS TO LOCATION-BASED EXPERIENCES

(71) Applicants: Drake Sutton-Shearer, Marina del Ray, CA (US); James Gatto, Vienna, VA (US)

(72) Inventors: Drake Sutton-Shearer, Marina del Ray, CA (US); James Gatto, Vienna, VA (US)

(21) Appl. No.: 17/804,308

(22) Filed: May 27, 2022

Related U.S. Application Data
(60) Provisional application No. 63/193,676, filed on May 27, 2021.

(51) Int. Cl. G06Q 20/36; H04L 9/32

(52) U.S. Cl. CPC G06Q 20/3678; G06Q 20/3672; H04L 9/3213; G06Q 2220/00

(57) ABSTRACT

Methods, systems, computing platforms, and storage media for creating and deploying location-based event-triggered cryptographic tokens for gated access to location-based experiences are disclosed. Exemplary implementations may: store location-based criteria; store a smart contract comprising computer code configured to mint a token and allocate the token to a user wallet in response to a user's location satisfying first location-based criteria; obtain location information from a user device; in response to a determination that the location information satisfies the location-based criteria, invoke the smart contract to mint a token and allocate the token to a user wallet; store a token-gated resource identifier for a resource and token criteria; and in response to a determination that the user satisfies the token criteria, grant the user access to the resource.

### CROSS-REFERENCE TO RELATED APPLICATION AND INCORPORATION BY REFERENCE

The present invention claims the benefit of priority to U.S. Prov. Pat. App. No. 63/193,676 filed May 27, 2022 (0100-923228-27MAY21), entitled CREATING AND DEPLOYING LOCATION-BASED EVENT-TRIGGERED CRYPTOGRAPHIC TOKENS FOR GATED ACCESS TO LOCATION-BASED EXPERIENCES (Sutton-Shearer), which is incorporated by reference herein in its entirety.

### FIELD OF THE DISCLOSURE

The present disclosure relates to creating and deploying location-based event-triggered cryptographic tokens (e.g., ERC-20 and/or ERC-721 tokens), for token-gated access to an experience and using proof of location oracles to validate user location.

### BACKGROUND

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token.

An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens.

With some tokens, the token may be minted on demand when the token creator decides to mint the token. Some fungible tokens are minted and initially allocated via an initial coin offering. Some tokens are “pre-mined” and subsequently allocated. For example, once minted, an NFT is typically offered for sale via an NFT marketplace or other token sale platform.

### SUMMARY

Methods, systems, computing platforms, and storage media for creating and deploying location-based event-triggered cryptographic tokens for gated access to location-based (or position-based) experiences are disclosed. The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, closed to external sources. This can be problematic when external data is needed to satisfy conditions of the smart contract.

One common location technology that may be used in connection with the invention is Global Positioning System (“GPS”) which provides users with positioning, navigation, and timing (PNT) services. The civilian facing portion of GPS is known as GPS Standard Positioning Service (SPS) Performance Standard and additional services are available via GPS Wide Area Augmentation Service Performance Standard. While GPS is a common location technology, sometimes the technology can be spoofed to falsely represent a user location. And because minting of tokens is typically managed via a smart contract, this makes conditional minting based on location challenging due to the limitations of smart contracts. For at least these reasons, GPS is not always suitable as a source of data for a smart contract or decentralized application (dApp) requiring reliable location information, because it can be a centralized point of failure that can be spoofed. According to some implementations, external data for use with a smart contract may be obtained by an oracle. The oracle may provide the smart contracts used with validated external data (including user location data). The smart contracts used may use an oracle to communicate with and take actions in response to external data and systems.

Other known protocols or platforms that provide location-based services include, e.g., UWB (Ultra-Wideband), RFID (Radio-Frequency Identification), Bluetooth (BR/EDR protocol), BLE (Bluetooth Low Energy—Bluetooth Smart), and NFC (Near Field Communication). These protocols are often deployed to provide highly effective communications between appropriately and compatibly equipped devices but also provide location services. Professional and standards setting bodies, including IEEE (Institute of Electrical and Electronics Engineers) and Bluetooth Special Interest Group (SIG), as well as universally available resources, including Wikipedia, provide open access to technical specifications and implementation information for each of these known platforms.

Many of these platforms are employed using IC (Integrated Chip) or microchip and antenna components and may involve use of SDR (Software-Defined Radio) and/or other embedded techniques. Each of the above-referenced protocols and platforms has advantages and disadvantages when compared with one another. For example, Bluetooth offers greater range when compared with UWB. However, and while Bluetooth/BLE have been adapted to provide location services, UWB has clear advantages over RFID, and Bluetooth/BLE in connection with applications requiring highly precise real-time location discovery and ranging services in a short-range use environment to scan, detect and determine spatial location and movements of detected or responding objects. An array of detectable objects may be deployed in support of such services and once connected, data may be communicated between devices using one or more or a combination of these protocols.

One important feature of such systems is the desire to provide secure transmissions and communications to avoid interception by unauthorized devices in proximity to the communications exchange. The platforms may use AES (Advanced Encryption Standard) encryption/decryption and application layer security. Applications may also employ known Public Key Infrastructure (PKI) and Public-Key Encryption (PKE) cryptography, or asymmetric cryptography. PKI is a platform that effectively binds public keys with identities through use of registration and issuance of digital certificates, such as issued by a known Certificate Authority (CA). PKI involves established policies and procedures required to create, manage, distribute, use, store and revoke digital certificates and manage PKE. PKE is a cryptographic system using pairs of keys, where each key-pair consists of a public key (which may be known to others) and a private key (which may not be known by anyone except the owner).

One aspect of the present disclosure relates to minting and allocating tokens based on location-triggered events and providing access to token-gated content in response to a user satisfying specified token criteria. Exemplary implementations may include storing location-based criteria. Exemplary implementations may include storing a smart contract including computer code configured to mint a token and allocate the token to a user wallet in response to a user's location satisfying first location-based criteria. Exemplary implementations may include obtaining location information from a user device. Exemplary implementations may include, in response to a determination that the location information satisfies the location-based criteria, invoking the smart contract to mint a token and allocate the token to a user wallet. Exemplary implementations may include storing a token-gated resource identifier for a resource and token criteria. Exemplary implementations may include, in response to a determination that the user satisfies the token criteria, granting the user access to the resource.

The system may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other consideration or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions.

Another aspect of the invention relates to minting and allocating cryptographic experiential tokens based on a location-based event and entitling the user to access an experience. The method may include storing first location-based criteria. Exemplary implementations may include determining that a user satisfies the first location-based criteria. Exemplary implementations may include allocating an experiential token to a digital wallet associated with the user. Exemplary implementations may include enabling the user to access the experience in response to determining the user holds the experiential token in its digital wallet.

Yet another aspect of the invention relates to granting token-gated access to a resource at a location based on location triggered events and providing access to token-gated content in response to a user satisfying specified token criteria. The method may include storing location-based criteria. Exemplary implementations may include storing a smart contract configured to mint a token and allocate it to a user wallet in response to a user's location satisfying first location-based criteria. Exemplary implementations may include obtaining location information from a user device. Exemplary implementations may include, in response to a determination that the location information satisfies the location-based criteria, invoking the smart contract to mint a token and allocate the token to the user wallet. Exemplary implementations may include storing a token-gated resource identifier for a resource. Exemplary implementations may include storing token criteria. Exemplary implementations may include, in response to a determination that the user satisfies the token criteria, granting the user access to the resource.

Still another aspect of the invention relates to granting token-gated access to a resource based on an NFT token comprising metadata including a reference to the resource. Exemplary implementations may include storing access criteria. Exemplary implementations may include determining a user possesses the non-fungible token and satisfies the access criteria. Exemplary implementations may include granting the user access to the resource.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a flow diagram for operating a decentralized application, in accordance with one or more implementations.

FIG. 2 illustrates a system configured for creating and deploying location-based event-triggered cryptographic tokens for gated access to location-based experiences, in accordance with one or more implementations.

FIGS. 3A, 3B, 3C, and/or 3D illustrate aspects of a method for creating and deploying location-based event-triggered cryptographic tokens for gated access to location-based experiences, in accordance with one or more implementations.

FIG. 3A provides a flow diagram illustrating a first aspect of a method for creating and deploying location-based event-triggered cryptographic tokens for gated access to location-based experiences, in accordance with one or more implementations.

FIG. 3B provides a flow diagram illustrating a second aspect of a method for creating and deploying location-based event-triggered cryptographic tokens for gated access to location-based experiences, in accordance with one or more implementations.

FIG. 3C provides a flow diagram illustrating a third aspect of a method for creating and deploying location-based event-triggered cryptographic tokens for gated access to location-based experiences, in accordance with one or more implementations.

FIG. 3D provides a flow diagram illustrating a fourth aspect of a method for creating and deploying location-based event-triggered cryptographic tokens for gated access to location-based experiences, in accordance with one or more implementations.

### DETAILED DESCRIPTION

Methods, systems, computing platforms, and storage media for creating and deploying location-based event-triggered cryptographic tokens for gated access to location-based experiences are disclosed. The existing token minting and sale process suffers from various technical drawbacks and limitations. For example, conventional smart contracts have numerous advantages but are limited in that typically they can operate only on the data contained inside the nodes of the blockchain on which they run. This makes them like a self-contained system, closed to external sources. This can be problematic when external data is needed to satisfy conditions of the smart contract.

While GPS is a common location technology, sometimes the technology can be spoofed to falsely represent a user location. And because minting of tokens is typically managed via a smart contract, this makes conditional minting based on location challenging due to the limitations of smart contracts. For at least these reasons, GPS is not always suitable as a source of data for a smart contract or decentralized application (dApp) requiring reliable location information, because it can be is a centralized point of failure that can be spoofed. According to some implementations, external data for use with a smart contract may be obtained by an oracle. The oracle may provide the smart contracts used with validated external data (including user location data). The smart contracts used may use an oracle to communicate with and take actions in response to external data and systems.

One aspect of the invention includes an NFT that is minted based on an event, for example, based on determining that sensor-based or other event data meets a predetermined condition. For example, the sensor may be a location-based sensor (e.g., based on GPS or other location data). An application may store a set of rules including certain conditions. When a rule is satisfied the application may trigger an instruction for a token (if pre-minted) to be allocated to the user or if not pre-minted, to be mined and allocated to the user. The rule may relate to location criteria (e.g., a specific location, a geofence or other location designator), time information (e.g., what time a user arrives or is present in accordance with location criteria) and/or other event information or conditions.

For example, when a user device having the sensor (or from which location data is sensed) and the application is located at a designated location that satisfies the location criteria of a rule, a token may be minted and/or allocated to the user (e.g., by transferring the token to a digital wallet associated with the user). This may be called an event-triggered token minting and/or allocation. If the event includes location criteria, this may be called a location-based event-triggered token minting and/or allocation. The user device location information may be automatically transmitted in some implementations and/or transmitted under user control in some implementations.

According to another aspect of the invention, the token (whether pre-minted or minted based on an event trigger) may be an experiential token. The experiential token may represent entitlement of the user to an experience, rather than just access to a digital file. For example, the experiential token may represent a right for a user to receive an experience based on user activation or a token activated trigger. The token may be a fungible token (e.g., an ERC-20 type token) or a non-fungible token (e.g., an ERC-721 or ERC 1155 type token).

For example, the token activation or trigger event may be the user being present at a predetermined location, such as an amusement park. When a user device running the application determines that the user has entered the amusement park (e.g., based on the detection of location information), this may cause a token to be minted, allocated, and/or transferred to a digital wallet associated with the user.

The token may be invoked via an application that may enable a user experience. In some implementations the experience may be related to the location and/or token issuer. For example, if the user device is a VR headset, AR device, or other XR device or application, a mascot for the amusement park may appear and offer a personal greeting to the user welcoming them to the park in the VR headset, AR device, or other XR device or application. In this case, the location may have computer or other equipment, software and/or content at the location (for convenience called location technology). Based on a location-based trigger, the location technology may interact with the application and/or the user to provide the user experience.

In another example, a user with the experiential token may trigger other types of experiences. According to one implementation, the experience may be a holographic display, a light field display, a 3D audio experience (e.g., using beam forming or other audio techniques), spatial audio and/or other visual, audible and/or multi-sensory experiences. Other experiences may be triggered by activation of an experiential token.

The location that triggers the minting and/or allocating of the token may be a first location different than a second location at which the user receives the experience. For example, in keeping with the amusement park example, the first location may be a location at or near the entrance to the park. Upon paying and/or entering the park, the user may trigger the minting and/or allocating of a token (e.g., an experiential token). When the user arrives at a second location the user may receive the experience. For example, as the user moves through the park and comes into proximity with a castle, a princess associated with the castle may be displayed to the user using the location technology and/or the user device and application.

If the token is an ERC-20 type or other fungible token, each user possessing such a token may receive the same experience. If the token is an ERC-721 type or other NFT, each user possessing such a token may receive an experience that is unique based on at least one attribute. A user may also transfer the NFT to another user or in some implementations temporarily transfer the NFT to another user for a period of time to fractionalize the ownership experience.

The application may be a mobile phone application based on iOS, Android, and/or other mobile operating system or may be a decentralized app or dApp. The dApp may connect with or include a digital wallet application (e.g., Metamask) to enable the transfer of tokens to the user. According to some implementations, the token entitles a user to one or more experiences, and the user maintains possession of the token. In some implementations, to access the experience or after accessing certain experiences, the token may be transferred from the user wallet (e.g., to the location operator, to a participant or participants who partake in providing the experience, to a token burn address to render the token useless or other wallet address).

According to another aspect of the invention, enhanced methods of verifying user location may be used. While GPS is a common location technology, sometimes the technology can be spoofed to falsely represent a user location. And because minting of tokens is typically managed via a smart contract, this makes conditional minting based on location challenging due to the limitations of smart contracts. For at least these reasons, GPS is not always suitable as a source of data for a smart contract or decentralized application (dApp) requiring reliable location information, because it can be is a centralized point of failure that can be spoofed. As discussed above, other alternative platforms offering location-based services include UWB, BLE, RFID, WiFi, and NFC and also cellular services.

A conventional “smart contract” is simply computer code or a set of computer program instruction that runs on a blockchain (e.g., the Ethereum blockchain). It is typically not a legal contract. Rather, it is a collection of code (its functions) and data (its state) that resides at a specific address on the blockchain. It is often called conditional logic or a set of if-then statements. A smart contract is programmed to determine when a condition occurs and in response to implement a function or take some action (e.g., if “this” happens, then do “that”). Smart contracts have numerous advantages but are limited in that typically they can operate only on the data contained inside the nodes of the blockchain on which they run. This makes them like a self-contained system, closed to external sources. This is by design for various reasons.

Conventionally, smart contracts typically cannot access data outside of their network. Yet, sometimes smart contracts need external information to function. In aspects of the present invention, one type of data that the minting and/or allocating smart contracts may need is location data (e.g., proof of user location).

According to one aspect of the invention, one option for obtaining external data for use with a smart contract is by an oracle. The oracle may provide the smart contracts used with validated external data (including user location data). The smart contracts used may use an oracle to communicate with and take actions in response to external data and systems.

Oracles, a type of smart contract, are services that insert data from the outside world into the blockchain for other smart contracts to use or consume and in essence provide a means for smart contracts to access data from the world outside the blockchain. More specifically, an oracle takes real-world off-chain data and submits an immutable copy of this information into blocks—making it available for future smart contract use. By adding a transaction with the required information to the blockchain the smart contract can run and always obtain the same information since it is retrieving it from the blockchain.

However, one risk with using external data “from the real world” (as opposed to that which is self-contained within the blockchain on which the smart contract runs), is that if the data or oracle is compromised then so can the entire smart contract.

Allowing smart contracts to take inputs from outside its blockchain is a double-edged sword; it increases the use implementations exponentially by allowing interactions with the external world, but it also introduces an element of trust. Miners on a permissionless blockchain cannot deterministically verify all external inputs and will therefore allow execution of anything which matches the predefined criteria of the smart contract.

Smart contracts on the Ethereum network can power a wide range of applications. However due to the nature of that blockchain, smart contracts lack an essential feature, namely internet connectivity. The Ethereum blockchain is designed to be entirely deterministic, meaning that if someone downloads the whole network history and replays it, they should always end up with the same state. Determinism is necessary so nodes can come to a consensus. However, the internet is not deterministic. A smart contract querying an API at a certain point in time, cannot be guaranteed that later querying the same API will get the same result. APIs and data on the web change. Therefore, by nature smart contracts lack connectivity.

According to one aspect of at least some implementations, the minting and/or allocation of tokens is implemented via one or more smart contracts. Minting tokens on the Ethereum platform can be performed using the “mint( )” function. Transfer may be implemented in a known manner from one digital wallet to another digital wallet.

In accordance with some implementations, smart contracts can be coded so they interact with one or more oracles to obtain location data and take action when certain location-based criteria are met. For example, one or more oracles may obtain location data (e.g., GPS data from a user's mobile device) to determine when a user's location meets certain location criteria associated with the one or more smart contracts. For example, a smart contract may be programmed so it mints and/or transfers to a user a token when an oracle indicates that a user is at or within a certain proximity to a specific location.

In some implementations, it may be desirable to ensure with greater certainty that a user is at a specific location. In such implementations the system described may use various tools to facilitate this. One example of such a tool is a decentralized oracle network that securely and reliably connects smart contracts to external data and systems. As one example, the described system may use a decentralized oracle network that uses multiple independent oracles to verify data and/or by aggregating data from multiple sources. For example, a decentralized oracle network may use technology provided by Chainlink (https://chain.link/) to securely connect smart contracts to IoT data, web APIs, and/or other data providers. According to some implementations, Chainlink and/or other decentralized oracles can enable a smart contract to receive verified location information about a user so the location-based minting of tokens can be reliably performed.

If there is a need to further verify a location to trigger an action to be implemented via a smart contract, a proof of location oracle for smart contracts may be used. Proof of location oracles do not necessarily rely on (centralized) GPS. This is a benefit because sometimes GPS data can be spoofed. Examples of spoofing or unreliable GPS service data includes intentional interference (jamming), unintentional interference, natural occurrences and coverage outage or discontinuity. More localized hacking of mobile devices are also sources of potential interference. Accordingly, decentralized proof of location blockchain services provide significant benefits.

For example, one such proof of location oracle may provide geo triangulations combined with a verified timestamp. Other alternatives may be used. The XYO Network (https://xyo.network/) has developed an oracle network to provide proof of location (POL). The XYO Network is a decentralized platform that helps smart contracts by using its ecosystem of devices to determine exactly where physical objects are at any specific time. The network uses a system of technological methods to confirm the certainty of its data. The XYO Network uses a system of four primary types of nodes to collate, store, and retrieve its data to answer user queries. These components are: (1) the “Sentinels” that collect location information via entities that include Bluetooth trackers, GPS trackers, IoT devices, satellite tracking technology, QR code scanners, and wireless scanning; (2) the “Bridges” that receive this location information from the Sentinels and process it before passing it on; (3) the “Archivists” that store and catalog the location information in smart contracts; and (4) the “Diviners” that retrieve, analyze, and rate the relevant stored data to answer incoming queries. Because these four components use certain protocols and algorithms to protect the accuracy of the data as it gets transmitted, XYO Network calls this process the “Proof of Origin Chain.” The intent is to resolve the “oracle problem” and to provide Proof of Location very difficult to spoof. Other proof of location oracles can be used with one or more aspects of the invention.

Various types of oracles exist and may be used with the implementations disclosed herein. Inbound oracles supply external data to a smart contract (e.g., GPS). Outbound oracles communicate data from smart contracts to an external network or blockchain. Consensus-based oracles rarely use a single source of data. There are several ways to create and use decentralized oracles. To reduce risk and provide more security, a combination of oracles may be used. For example, the average of several oracles may be used. A consensus of m of n oracles can determine the outcome of an event. Consensus-based oracles are slower, because it takes more time to reach consensus, but they provide greater confidence in the data.

A decentralized application (dApp) is an application built on a decentralized network that combines a smart contract and a frontend user interface. A dApp has its back end code running on a decentralized network as opposed to an app where the back end code is running on centralized servers. The frontend can be hosted on decentralized storage system such as the interplanetary files system (IPFS).

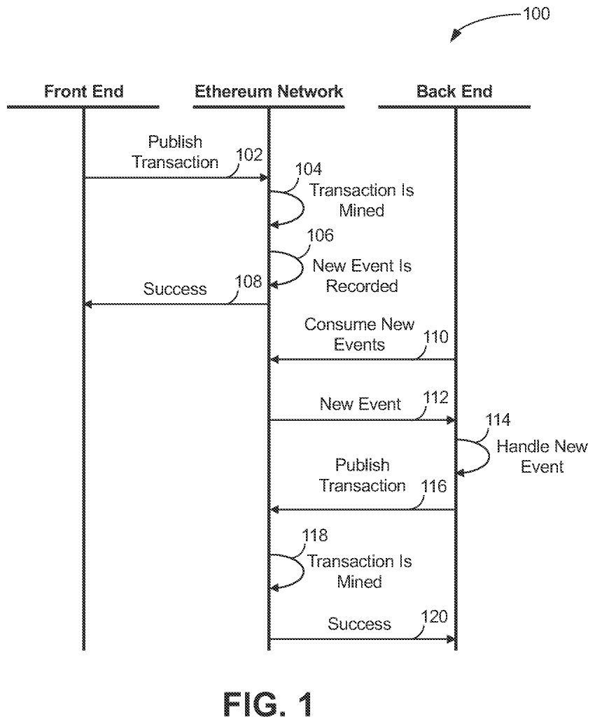

FIG. 1 illustrates a flow diagram 100 for operating a decentralized application, in accordance with one or more implementations. The flow diagram shows operations performed by and between a front end (e.g., a user interface, browser, etc.), the Ethereum network (although other blockchains could be substituted), and a back end (e.g., a server or user device). The operations of flow diagram 100 presented below are intended to be illustrative. In some implementations, the operations of flow diagram 100 may be accomplished with one or more additional operations not described, and/or without one or more of the operations discussed. Additionally, the order in which the operations of flow diagram 100 are illustrated in FIG. 1 and described below is not intended to be limiting.

An operation 102 may include the front end effectuating a transaction being published to the Ethereum network. An operation 104 may include a transaction being mined at the Ethereum network. An operation 106 may include a new event being recorded at the Ethereum network. An operation 108 may include the front end receiving a success indication from the Ethereum network. An operation 110 may include new events being consumed between the back end and the Ethereum network. An operation 112 may include a new event being communicated to the back end from the Ethereum network. An operation 114 may include the new event being handled at the back end. An operation 116 may include the back end effectuating a transaction being published to the Ethereum network. An operation 118 may include a transaction being mined at the Ethereum network. An operation 120 may include the back end receiving a success indication from the Ethereum network.

Companies may offer rewards or other benefits to consumers by minting fungible tokens NFTs directly linked to a consumer's location. Chainlink can use IoT data to mint coupons based on verifiable user presence.

According to another aspect of the invention, the system may provide token-enabled experiences. For simplicity, this concept will be described regarding a token providing access to a page. However, the page may be replaced by any other suitable resource. The page may be a website that provides access to content, experiences or other resources.

Some implementations may rely on technology that uses token protected pages (TPPs). TPPs are essentially secret links that point to gated webpages. For example, in some implementations the system may enable the association of a token (via its metadata) with a page URL or URI (e.g., from Web2 platforms) and then generate a new, secret URL protected by a specified fungible or non-fungible token. When a user opens the secret URL, the user application may check to see if their Web3 connected digital wallet (i.e., MetaMask) holds the correct token. If the user wants access, but they do not own the specified token, they may not access the content. This feature enables the application to ensure that a user has a token to gain access to an experience or other resource. Various technologies exist in general to facilitate TPPs such as Mintgate. In this way, for example, NFTs can be used for event ticketing, passes or other event or experience access. Another example of using NFTs is for token-enabled content. This idea is similar to paying to access content behind a paywall but requiring the user to possess a token (e.g., fungible or an NFT) for access.

The concepts of the implementations disclosed herein may be used at or with a variety of locations and location types, including, without limitation, entertainment venues (e.g., theme parks, sports stadiums, nightclubs, restaurants, movie theaters, bars, and/or other entertainment venues), tourist attractions, retail stores, malls and/or other public venues, toll roads, parking garages, within and around autonomous vehicles, and/or various other locations.

In some implementations, the NFT token may point to a URI via the metadata in the token definition. For example, the URI may point to a resource that includes an AR, VR, and/or other XR experience linked to a location. Location-based XR may include associating an XR and/or other resource with a location and triggering the resource when a user device is detected at the location and the user possesses an access token for that resource. The resource may be a 2D or 3D media file, a hologram, a sound-based experience (e.g., via beamforming), an olfactory and/or taste experience via activated hardware to evoke a specific feeling, and/or other resources.

In some implementations, the NFT may be redeemed for an experience. In some implementations a single token may provide access to multiple resources at the same or multiple locations and/or the same resource(s) multiple times.

The location may use one or more beacons and/or other location technology to interact with the application. For example, the beacons may use proximity technology to detect the user's presence at a location and trigger preset actions to deliver informational, contextual, and/or personalized experiences, and if desired, only if the user possesses the appropriate access token.

This enables a user device, when the user enters a location matching the stored location criteria, to be detected (e.g., via a GPS, BLE, or UWB capability on their phone or other mobile device) and for the application on their phone to activate the resource (e.g., the XR experience) and if so, configured only if the user possesses that access token. Alternatively, this enables a user device, when the user enters a location matching the stored location criteria, to be detected (e.g., via a GPS, BLE, or UWB capability on their phone or other mobile device) and for technology at the location to activate the resource (e.g., video, audio, multimedia) in proximity of the user.

The system may include and/or interface with one or more blockchain and/or other decentralized ledger networks.

Various users may have mobile devices (e.g., smart phones, tablets and/or other mobile devices). In some implementations, the mobile devices may include an application that includes and/or interfaces with a digital wallet (e.g., MetaMask and/or other digital wallet) that enables a user or user application to engage in cryptocurrency and/or crypto token transactions (including NFTs). The mobile device may further include one or more position detecting sensor (e.g., a GPS or BLE or UWB sensor) to locate the device/user location and/or other location transmitting or receiving devices.

One or more location venues may include position detecting technology at various locations throughout the venue and various devices that can be activated and/or otherwise controlled to create a multimedia experience for users. The devices may include video projectors, holographic display devices or other video devices, audio speakers, beam forming devices and/or other audio devices, devices for generating AR, VR, and/or other XR devices.

Various technologies can be a basis for enabling portions of the system. Examples of some of the existing technologies include IoTeX, the Pebble/Pebble Tracker, and/or other existing technologies. IoTeX (https://iotex.io/) provides verifiable GPS data to mint NFTs that establish that a user was present at a certain location at a certain time. Pébble GO (https://pebblego.io/) is a dApp running on the IoTeX blockchain, designed as a space for trading and exchanging non-fungible tokens (NFTs) through “proof of presence” by utilizing trusted wearables and trackers to verify claims of location. Pébble GO helps connect physical and virtual worlds through blockchain-based verification of actual presence with trusted devices. This enables a collection of NFTs that are only mintable under verifiable conditions (e.g., through a location-based ‘proof of presence). The Pebble Tracker is a multi-sensor IoT data oracle that uses a tamper-proof secure element (TEE) to convert real world phenomena into verifiable, blockchain-ready data.

One problem with known geolocation tools is that they cannot offer reliable and trusted location verification services. It is possible for attackers to spoof other people's GPS devices and it is trivial to fake a device's location. GPS is a highly centralized, non-encrypted system, without a proof-of-origin. Exemplary implementations may fork the Ethereum blockchain to modify smart contracting language so it becomes a location-aware language, which can be used for requesting and defining secure location proofs on the blockchain. Exemplary implementations may provide a blockchain that gives users control over their location data as they own the data on the provided blockchain and can choose to whom it can be exposed. Some implementations may enable users to control with which locations they share their location date.

Some implementations may provide a protocol that is based on zero knowledge proofs. A Zero Knowledge Proof (ZKP) may include a method by which one party (the prover) can prove to another party (the verifier) that she knows a value X, without revealing the value itself. This is a very useful way of sharing information without disclosing the actual information. Exemplary implementations include nodes that use ZKP to achieve blinding regarding location information. For example, a node can prove that it is within a region, say a certain zip code, without sharing its actual location. More elaborate ZKP applications can prove that a node met all the conditions of a contract, without revealing anything else. Some implementations may provide digital assets a real, fixed location on a map.

The digital asset can be an entitlement to an experience or other location-based resource in connection with various implementations disclosed herein.

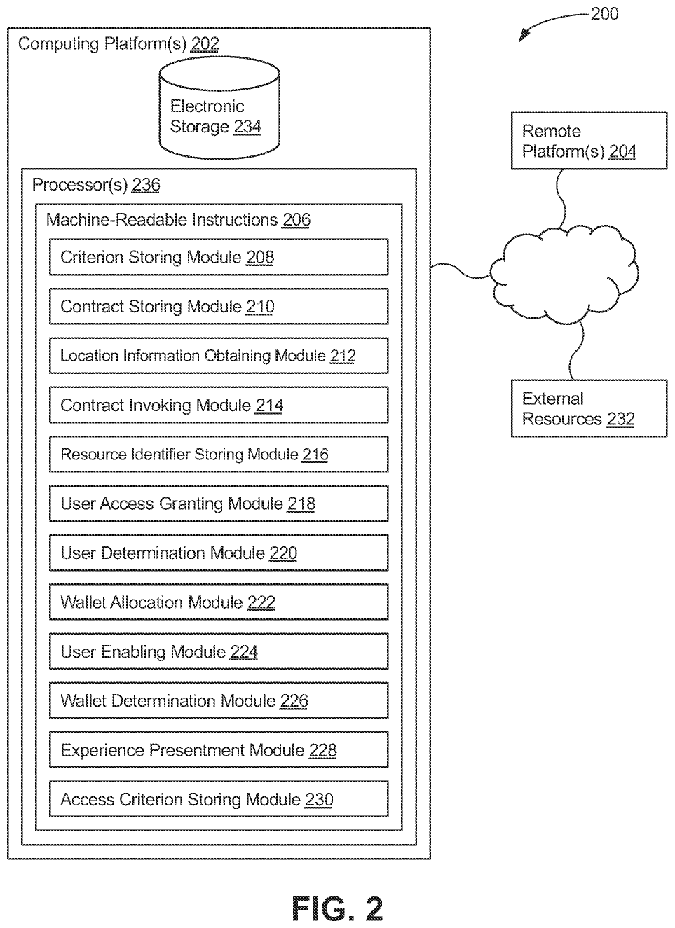

FIG. 2 illustrates a system 200 configured for creating and deploying location-based event-triggered cryptographic tokens for gated access to location-based experiences, in accordance with one or more implementations. In some implementations, system 200 may include one or more computing platforms 202. The computing platform 202 may include one or more processors and a set of computer program modules, which may include sets of instructions adapted to be executed by the one or more processors and stored in one or memory components of the computing platform 202 and adapted to access and retrieve data stored in a memory or data storage component. Computing platform 202 may include one or more user input or user interface device and a display for presenting user interface elements and other graphical elements. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of criterion storing module 208, contract storing module 210, location information obtaining module 212, contract invoking module 214, resource identifier storing module 216, user access granting module 218, user determination module 220, wallet allocation module 222, user enabling module 224, wallet determination module 226, experience presentment module 228, access criterion storing module 230, and/or other instruction modules.

Criterion storing module 208 may be configured to store location-based criteria. By way of non-limiting example, the location-based criteria may be based on one or more of a specific location, a geofence, a location designator, and/or time information. The device may be at a location during a time associated with the time information. Criterion storing module 208 may be configured to store first location-based criteria. Satisfying first location-based criteria may include one or more of the user devices arriving at the specific location. Criterion storing module 208 may be configured to store second location-based criteria. Criterion storing module 208 may be configured to store token criteria and other criteria.

Contract storing module 210 may be configured to store a smart contract including computer code configured to mint a token and allocate the token to a user wallet in response to a user's location satisfying first location-based criteria. Contract storing module 210 may be configured to store a smart contract configured to mint a token and allocate it to a user wallet in response to a user's location satisfying first location-based criteria.

Location information obtaining module 212 may be configured to obtain location information from a user device. Obtaining location information from a user device may include interacting with an oracle configured to provide the smart contract with validated external data including device location data. Other location information may be obtained in other ways described herein or other known techniques.

Contract invoking module 214 may be configured to, in response to a determination that the location (or other criteria) information satisfies the location-based criteria, invoke the smart contract to mint a token and allocate the token to a user wallet.

Resource identifier storing module 216 may be configured to store a token-gated resource identifier for a resource. The token-gated resource identifier may be configured to identify the resource. The token-gated resource identifier may include one or both of a secret uniform resource locator and/or a secret uniform resource identifier. The secret uniform resource locator and/or the secret uniform resource identifier may be protected by the token. The token may be a fungible token or a non-fungible token. By way of non-limiting example, the resource may include one or more of a website that provides access to content or an experience, an extended reality experience associated with a location, a video, an audio file, a multimedia file, a two-dimensional or three-dimensional media file, a hologram, a sound-based experience, and/or an olfactory and/or taste experience via activated hardware to evoke a specific feeling.

Resource identifier storing module 216 may be configured to store a token-gated resource identifier for a resource and token criteria. By way of non-limiting example, the token criteria may include one or more of first location-based criteria, second location-based criteria, and/or time-based criteria, the first location-based criteria and the second location-based criteria being associated with different locations. Other token criteria may be used.

User access granting module 218 may be configured to grant the user access to the resource. User access granting module 218 may be configured to, in response to a determination that the user satisfies the token criteria, grant the user access to the resource. For example, the user device may breach the geofence or otherwise satisfy location criteria. The user device may arrive at a location associated with the location designator.

User determination module 220 may be configured to, in response to a request from a user to access the resource, determine if the user satisfies the token criteria. User determination module 220 may be configured to determine that a user satisfies the first location-based criteria. User determination module 220 may be configured to determine that a user satisfies the second location-based criteria.

Wallet allocation module 222 may be configured to allocate an experiential token to a digital wallet associated with the user. The mechanics of allocating a token to a wallet, in general, using existing blockchain technology is known.

User enabling module 224 may be configured to enable the user to access the experience in response to determining the user holds the experiential token in its digital wallet.

Wallet determination module 226 may be configured to determine that a digital wallet associated with the user holds an experiential token related to the second location-based criteria. The experiential token may represent entitlement of the user to an experience. The experiential token may represent a right for the user to receive an experience based on user activation or a token activated trigger.

Experience presentment module 228 may be configured to present the experience in response to determining the user holds the experiential token in a digital wallet associated with the user. Presenting the experience may include presenting information associate with the experience via a user device associated with the user.

Access criterion storing module 230 may be configured to store access criteria. The access criteria may include one or both of location-based criteria and/or time-based criteria. User determination module 220 may be configured to determine a user possesses the non-fungible token and satisfies the access criteria.

In some implementations, computing platform(s) 202, remote platform(s) 204, and/or external resources 232 may be operatively linked via one or more electronic communication links over one or more communication networks including one or more wired and/or wireless networks—illustrated in FIG. 2 as a cloud-shaped representation. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 232 may be operatively linked via some other communication media.

A given remote platform 204 may include one or more processors configured to execute computer program modules. The computer program modules may include sets of instructions stored in one or memory components of the remote platform and adapted to access and retrieve data stored in a memory or data storage component. The computer program modules may be configured to enable an expert or user associated with the given remote platform 204 to interface with system 200 and/or external resources 232, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 232 may include sources of information outside of system 200, external entities participating with system 200, and/or other resources. In some implementations, some or all of the functionality attributed herein to external resources 232 may be provided by resources included in system 200.

Computing platform(s) 202 may include one or more electronic storage and/or memory components 234, one or more processors 236, user interface components and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage or memory component 234 may comprise non-transitory storage media that electronically stores information and may include traditional memory component(s) and storage component(s). The memory/storage may be allocated for efficient processing associated with short-term and long-term or persistent use. The electronic storage media of electronic storage 234 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 234 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 234 may include one or more virtual storage resources (e.g., cloud storage, a virtual private network, and/or other virtual storage resources). Electronic storage 234 may store software algorithms, information determined by processor(s) 236, information received from computing platform(s) 202, information received from remote platform(s) 204, and/or other information that enables computing platform(s) 202 to function as described herein.

Processor(s) 236 may be configured to provide information processing capabilities in computing platform(s) 202 and may be implemented in a distributed architecture. As such, processor(s) 236 may include one or more of a digital processor, an analog processor, a digital circuit designed to process information, an analog circuit designed to process information, a state machine, and/or other mechanisms for electronically processing information. Although processor(s) 236 is shown in FIG. 2 as a single entity, this is for illustrative purposes only. In some implementations, processor(s) 236 may include a plurality of processing units. These processing units may be physically located within the same device, or processor(s) 236 may represent processing functionality of a plurality of devices operating in coordination. Processor(s) 236 may be configured to execute modules 208, 210, 212, 214, 216, 218, 220, 222, 224, 226, 228, and/or 230, and/or other modules. Processor(s) 236 may be configured to execute modules 208, 210, 212, 214, 216, 218, 220, 222, 224, 226, 228, and/or 230, and/or other modules by software; hardware; firmware; some combination of software, hardware, and/or firmware; and/or other mechanisms for configuring processing capabilities on processor(s) 236. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, and/or 230 are illustrated in FIG. 2 as being implemented within a single processing unit, in implementations in which processor(s) 236 includes multiple processing units (on in which the platform is a distributed platform), one or more of modules 208, 210, 212, 214, 216, 218, 220, 222, 224, 226, 228, and/or 230 may be implemented remotely from the other modules. The description of the functionality provided by the different modules 208, 210, 212, 214, 216, 218, 220, 222, 224, 226, 228, and/or 230 described below is for illustrative purposes, and is not intended to be limiting, as any of modules 208, 210, 212, 214, 216, 218, 220, 222, 224, 226, 228, and/or 230 may provide more or less functionality than is described. For example, one or more of modules 208, 210, 212, 214, 216, 218, 220, 222, 224, 226, 228, and/or 230 may be eliminated, and some or all of its functionality may be provided by other ones of modules 208, 210, 212, 214, 216, 218, 220, 222, 224, 226, 228, and/or 230. As another example, processor(s) 236 may be configured to execute one or more additional modules that may perform some or all of the functionality attributed below to one of modules 208, 210, 212, 214, 216, 218, 220, 222, 224, 226, 228, and/or 230.

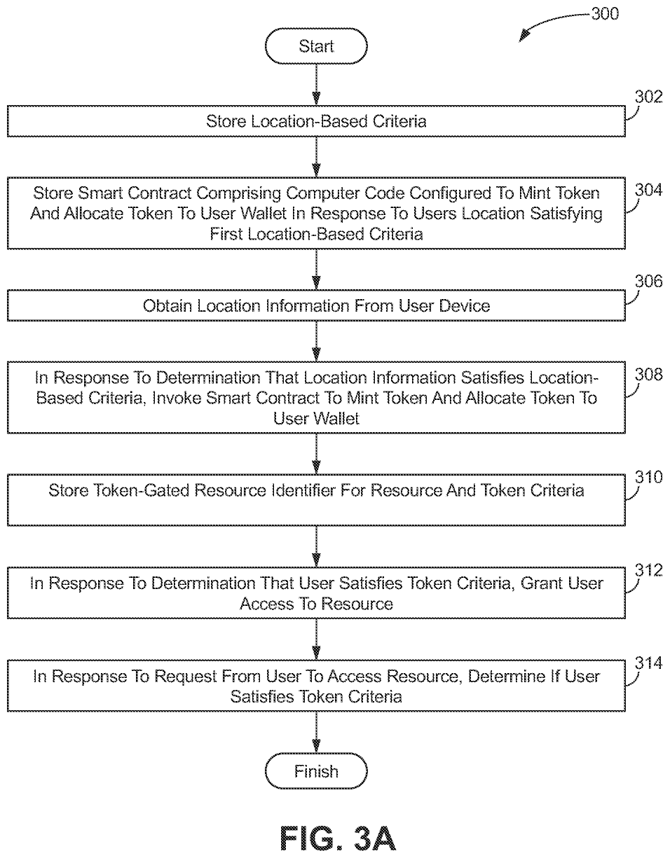

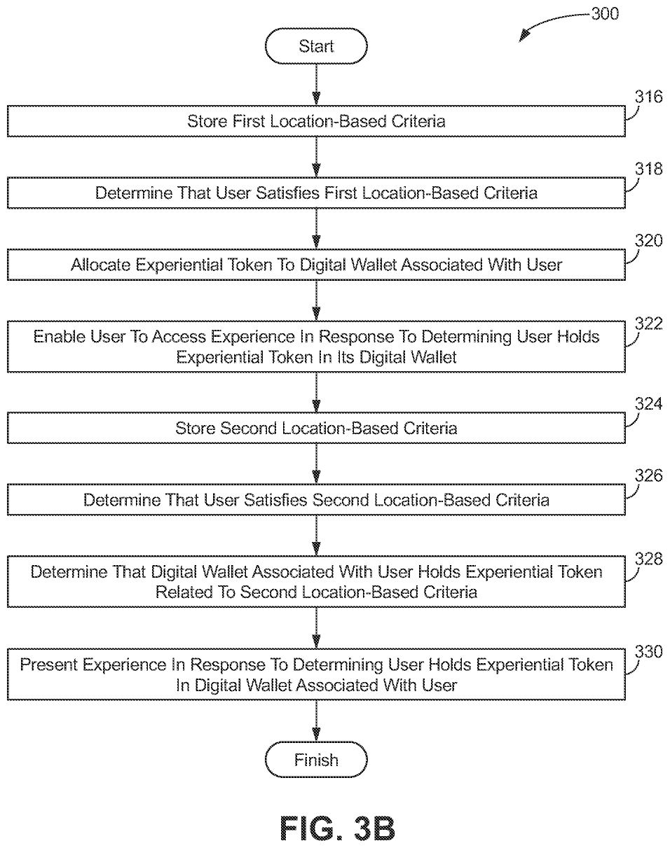

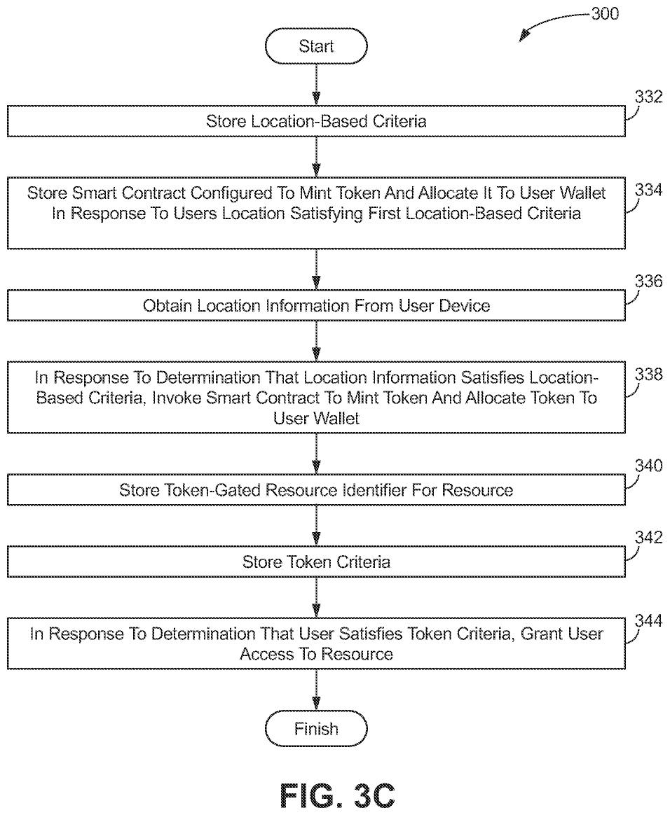

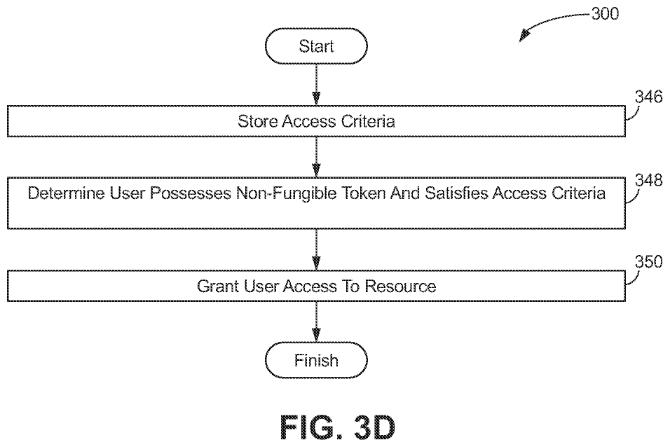

FIGS. 3A, 3B, 3C, and/or 3D illustrates a method 300 for creating and deploying location-based event-triggered cryptographic tokens for gated access to location-based experiences, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIGS. 3A, 3B, 3C, and/or 3D and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

FIG. 3A illustrates method 300, in accordance with one or more implementations, including minting and allocating tokens based on location-triggered events and providing access to token-gated content in response to a user satisfying specified token criteria.

An operation 302 may include storing location-based criteria. Operation 302 may be performed by one or more hardware processors configured by machine-readable instructions including a module that is the same as or similar to criterion storing module 208, in accordance with one or more implementations.

An operation 304 may include storing a smart contract including computer code configured to mint a token and allocate the token to a user wallet in response to a user's location satisfying first location-based criteria. Operation 304 may be performed by one or more hardware processors configured by machine-readable instructions including a module that is the same as or similar to contract storing module 210, in accordance with one or more implementations.

An operation 306 may include obtaining location information from a user device. Operation 306 may be performed by one or more hardware processors configured by machine-readable instructions including a module that is the same as or similar to location information obtaining module 212, in accordance with one or more implementations.

An operation 308 may include in response to a determination that the location information satisfies the location-based criteria, invoking the smart contract to mint a token and allocate the token to a user wallet. Operation 308 may be performed by one or more hardware processors configured by machine-readable instructions including a module that is the same as or similar to contract invoking module 214, in accordance with one or more implementations.

An operation 310 may include storing a token-gated resource identifier for a resource and token criteria. Operation 310 may be performed by one or more hardware processors configured by machine-readable instructions including a module that is the same as or similar to resource identifier storing module 216, in accordance with one or more implementations.

An operation 312 may include in response to a determination that the user satisfies the token criteria, granting the user access to the resource. Operation 312 may be performed by one or more hardware processors configured by machine-readable instructions including a module that is the same as or similar to user access granting module 218, in accordance with one or more implementations. The resource may include viewing and interactive media or other digital media file (e.g., via the application) or otherwise accessing the resource in a known manner.

An operation 314 may further include, in response to a request from a user to access the resource, determining if the user satisfies the token criteria. This may be determined based on stored criteria and/or rules and data regarding the user location and/or other criteria. Operation 314 may be performed by one or more hardware processors configured by machine-readable instructions including a module that is the same as or similar to user determination module 220, in accordance with one or more implementations.

FIG. 3B illustrates method 300, in accordance with one or more implementations, including minting and allocating cryptographic experiential tokens based on a location-based event and entitling the user to access an experience.

An operation 316 may include storing first location-based (or other) criteria. Operation 316 may be performed by one or more hardware processors configured by machine-readable instructions including a module that is the same as or similar to criterion storing module 208, in accordance with one or more implementations.

An operation 318 may include determining that a user satisfies the first location-based (or other) criteria. Operation 318 may be performed by one or more hardware processors configured by machine-readable instructions including a module that is the same as or similar to user determination module 220, in accordance with one or more implementations.

An operation 320 may include allocating an experiential token to a digital wallet associated with the user. Operation 320 may be performed by one or more hardware processors configured by machine-readable instructions including a module that is the same as or similar to wallet allocation module 222, in accordance with one or more implementations.

An operation 322 may include enabling the user to access the experience in response to determining the user holds the experiential token in its digital wallet. Operation 322 may be performed by one or more hardware processors configured by machine-readable instructions including a module that is the same as or similar to user enabling module 224, in accordance with one or more implementations.

An operation 324 may include storing second location-based (or other) criteria. Operation 324 may be performed by one or more hardware processors configured by machine-readable instructions including a module that is the same as or similar to criterion storing module 208, in accordance with one or more implementations.

An operation 326 may include determining that a user satisfies the second location-based (or other) criteria. Operation 326 may be performed by one or more hardware processors configured by machine-readable instructions including a module that is the same as or similar to user determination module 220, in accordance with one or more implementations.

An operation 328 may include determining that a digital wallet associated with the user holds an experiential token related to the second location-based (or other) criteria. Operation 328 may be performed by one or more hardware processors configured by machine-readable instructions including a module that is the same as or similar to wallet determination module 226, in accordance with one or more implementations.

An operation 330 may include presenting the experience in response to determining the user holds the experiential token in a digital wallet associated with the user. Operation 330 may be performed by one or more hardware processors configured by machine-readable instructions including a module that is the same as or similar to experience presentment module 228, in accordance with one or more implementations.

FIG. 3C illustrates method 300, in accordance with one or more implementations, including granting token-gated access to a resource at a location based on location triggered events (or other token criteria) and providing access to token-gated content in response to a user satisfying specified token criteria.

An operation 332 may include storing location-based (or other) criteria. Operation 332 may be performed by one or more hardware processors configured by machine-readable instructions including a module that is the same as or similar to criterion storing module 208, in accordance with one or more implementations.

An operation 334 may include storing a smart contract configured to mint a token and allocate it to a user wallet in response to a user's location satisfying first location-based (or other) criteria. Operation 334 may be performed by one or more hardware processors configured by machine-readable instructions including a module that is the same as or similar to contract storing module 210, in accordance with one or more implementations.

An operation 336 may include obtaining location information (or other information) from a user device. Operation 336 may be performed by one or more hardware processors configured by machine-readable instructions including a module that is the same as or similar to location information obtaining module 212, in accordance with one or more implementations.

An operation 338 may include in response to a determination that the location (or other) information satisfies the location-based (or other) criteria, invoking the smart contract to mint a token and allocate the token to the user wallet. Operation 338 may be performed by one or more hardware processors configured by machine-readable instructions including a module that is the same as or similar to contract invoking module 214, in accordance with one or more implementations.

An operation 340 may include storing a token-gated resource identifier for a resource. Operation 340 may be performed by one or more hardware processors configured by machine-readable instructions including a module that is the same as or similar to resource identifier storing module 216, in accordance with one or more implementations.

An operation 342 may include storing token criteria. Operation 342 may be performed by one or more hardware processors configured by machine-readable instructions including a module that is the same as or similar to criterion storing module 208, in accordance with one or more implementations.

An operation 344 may include in response to a determination that the user satisfies the token criteria, granting the user access to the resource. Operation 344 may be performed by one or more hardware processors configured by machine-readable instructions including a module that is the same as or similar to user access granting module 218, in accordance with one or more implementations.

FIG. 3D illustrates method 300, in accordance with one or more implementations, including granting token-gated access to a resource based on an NFT token comprising metadata including a reference to the resource.

An operation 346 may include storing access criteria. Operation 346 may be performed by one or more hardware processors configured by machine-readable instructions including a module that is the same as or similar to access criterion storing module 230, in accordance with one or more implementations.

An operation 348 may include determining a user possesses the non-fungible token and satisfies the access criteria. Operation 348 may be performed by one or more hardware processors configured by machine-readable instructions including a module that is the same as or similar to user determination module 220, in accordance with one or more implementations.

An operation 350 may include granting the user access to the resource. Operation 350 may be performed by one or more hardware processors configured by machine-readable instructions including a module that is the same as or similar to user access granting module 218, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for minting and allocating tokens based on location-triggered events and providing access to token-gated content in response to a user satisfying specified token criteria, the method comprising:
storing location-based criteria;
storing a smart contract comprising computer code configured to mint a token and allocate the token to a user wallet in response to a user's location satisfying first location-based criteria;
obtaining location information from a user device;
in response to a determination that the location information satisfies the location-based criteria, invoking the smart contract to mint a token and allocate the token to a user wallet;
storing a token-gated resource identifier for a resource and token criteria; and
in response to a determination that the user satisfies the token criteria, granting the user access to the resource.

2. The method of claim 1, further comprising, in response to a request from a user to access the resource, determining if the user satisfies the token criteria.

3. The method of claim 1, wherein the location-based criteria is based on one or more of a specific location, a geofence, a location designator, and/or time information.

4. The method of claim 3, wherein satisfying first location-based criteria includes one or more of the user device arriving at the specific location, the user device breaching the geofence, the user device arriving at a location associated with the location designator, and/or the user device being at a location during a time associated with the time information.

5. The method of claim 1, wherein obtaining location information from a user device includes interacting with an oracle configured to provide the smart contract with validated external data including device location data.

6. The method of claim 1, wherein the token-gated resource identifier is configured to identify the resource, the token-gated resource identifier including one or both of a secret uniform resource locator and/or a secret uniform resource identifier, the secret uniform resource locator and/or the secret uniform resource identifier being protected by the token.

7. The method of claim 1, wherein the resource includes one or more of a website that provides access to content or an experience, an extended reality experience associated with a location, a video, an audio file, a multimedia file, a two-dimensional or three-dimensional media file, a hologram, a sound-based experience, and/or an olfactory and/or taste experience via activated hardware to evoke a specific feeling.

8. The method of claim 1, wherein the token criteria include one or more of first location-based criteria, second location-based criteria, and/or time-based criteria, the first location-based criteria and the second location-based criteria being associated with different locations.

9. A method for minting and allocating cryptographic experiential tokens based on a location-based event and entitling the user to access an experience, the method comprising:
storing first location-based criteria;
determining that a user satisfies the first location-based criteria;
allocating an experiential token to a digital wallet associated with the user; and
enabling the user to access the experience in response to determining the user holds the experiential token in its digital wallet.

10. The method of claim 9, wherein the experiential token represents entitlement of the user to an experience.

11. The method of claim 9, wherein the experiential token represents a right for the user to receive an experience based on user activation or a token activated trigger.

12. The method of claim 9, wherein the token is a fungible token or a non-fungible token.

13. The method of claim 9, further comprising:
storing second location-based criteria;
determining that a user satisfies the second location-based criteria;
determining that a digital wallet associated with the user holds an experiential token related to the second location-based criteria; and
presenting the experience in response to determining the user holds the experiential token in a digital wallet associated with the user.

14. The method of claim 13, wherein presenting the experience includes presenting information associate with the experience via a user device associated with the user.

15. A method for granting token-gated access to a resource at a location based on location triggered events and providing access to token-gated content in response to a user satisfying specified token criteria, the method comprising:
storing location-based criteria;
storing a smart contract configured to mint a token and allocate it to a user wallet in response to a user's location satisfying first location-based criteria;
obtaining location information from a user device;
in response to a determination that the location information satisfies the location-based criteria, invoking the smart contract to mint a token and allocate the token to the user wallet;
storing a token-gated resource identifier for a resource;
storing token criteria; and
in response to a determination that the user satisfies the token criteria, granting the user access to the resource.

16. A method for granting token-gated access to a resource based on a non-fungible token comprising metadata including a reference to the resource, the method comprising:
storing access criteria;
determining a user possesses the non-fungible token and satisfies the access criteria; and
granting the user access to the resource.

17. The method of claim 16, wherein the access criteria include one or both of location-based criteria and/or time-based criteria.

18. A system for minting and allocating tokens based on location-triggered events and providing access to token-gated content in response to a user satisfying specified token criteria, comprising:
a processor;
computer instructions, which when executed by the processor, cause the processor to:
store location criteria;
store a smart contract comprising computer code configured to mint a token and allocate it to a user wallet in response to a user's location satisfying first location criteria;
obtain location information from a user device;
in response to a determination that the location information satisfies the location criteria, invoke the smart contract to mint a token and allocate the token to a user wallet;
store a token-gated resource identifier for a resource and token criteria; and
in response to a determination that the user satisfies the token criteria, grant the user access to the resource.

19. The system of claim 18, wherein the processor is further configured, in response to a request from a use to access the resource, to determine if the user satisfies the token criteria.

20. A system for minting and allocating cryptographic, experiential tokens based on a location-based event, the experiential token entitling the user to access an experience, comprising:
a processor programmed with computer instructions, which when executed, cause the processor to:
store first location-based criteria;
determine that a user satisfies the first location-based criteria;
allocate an experiential token to a digital wallet associated with the user; and
enable the user to access the experience in response to determining the user holds the experiential token in its digital wallet.

21. The system of claim 20, the processor further configured to:
store second location-based criteria;
determine that a user satisfies the second location-based criteria;
determine that a digital wallet associated with the user holds an experiential token related to the second location-based criteria; and
present the experience in response to determining the user holds the experiential token in its digital wallet.

22. A system for granting token-gated access to a resource at a location based on location-triggered events and providing access to token-gated content in response to a user satisfying specified token criteria, comprising:
a processor programmed with computer instructions, which when executed by the processor, cause the processor to:
store location criteria;
store a smart contract configured to mint a token and allocate it to a user wallet in response to a user's location satisfying first location criteria;
obtain location information from a user device;
in response to a determination that the location information satisfies the location criteria, invoke the smart contract to mint a token and allocate the token to the user wallet;
store a token-gated resource identifier for a resource;
store token criteria; and
in response to a determination that the user satisfies the token criteria, grant the user access to the resource.

23. A system for granting token-gated access to a resource based on a non-fungible token comprising metadata including a reference to the resource, comprising:
a processor, programmed with computer instructions, which when executed by the processor, cause the processor to:
store access criteria;
determine a user possesses the non-fungible token and satisfies the access criteria; and
grant the user access to the resource.
